(19) United States
(12) Patent Application Publication
(10) Pub. No.: US 2024/0080199 A1
(43) Pub. Date: Mar. 7, 2024

(54) SECURE MULTI-FACTOR ENCRYPTED AUTHENTICATION SYSTEM

(71) Applicant: Phunware, Inc., Austin, TX (US)

(72) Inventors: Gustavo Di Martino, Mission Viejo, CA (US); Randall Crowder, Austin, TX (US); Andrew Soltan, Orange, CA (US); Dustin Tran, Tustin, CA (US)

(21) Appl. No.: 17/900,978

(22) Filed: Sep. 1, 2022

(51) Int. Cl. H04L 9/32; H04L 9/00; H04L 9/08; H04L 9/40

(52) U.S. Cl. CPC H04L 9/3226; H04L 9/0825; H04L 9/50; H04L 63/10

(57) ABSTRACT

A secure multi-factor encrypted authentication method includes creating a Secure Personal Identifier (SPI) to authenticate the identity of a user, storing the SPI in immutable storage using an asymmetric encryption object of the user, and using the SPI to allow secure access to a digital resource. A multi-factor encrypted authentication system includes an access portal including an asymmetric encryption object, an immutable storage communicating with the access portal using the asymmetric encryption object, an identity server communicating with both the access portal and the immutable storage, and a filing system receiving identity information from the identity server and returning a hash (CID).

### BACKGROUND

Various applications and other digital resources (“digital resources”) can be accessed from computing devices such as computers, smartphones, tablets, etc. Quite often, digital resources include security features to prevent unauthorized access. For example, it is quite common for a digital resource to require a username and password before allowing access to its functionality. When the digital resource is particularly sensitive, e.g is an application allowing access to banking records or to a government website, additional security is provided by requiring a second tier of security. For example, some applications may send a random code to a user in an SMS or email message which must be then entered into the application to gain access to its functionality. Since the user, presumably, is the owner of the mobile telephone and/or email address, a personal identity can be confirmed with a high level of confidence.

Prior art security systems as describe above can be effective but are cumbersome and slow. For example, users may have many different accounts with many different usernames and passwords, requiring them to remember which usernames and passwords are associated with a particular digital resource. This sometimes requires recovering or resetting a username and/or password. Also, with second tier security it is somewhat cumbersome to retrieve the random code sent as an SMS or email message and enter it into the resource, especially if the code is hard to remember.

These and other limitations of the prior art will become apparent to those of skill in the art upon a reading of the following descriptions and a study of the several figures of the drawing.

### SUMMARY

An example secure multi-factor encrypted authentication method includes creating a Secure Personal Identifier (SPI) to authenticate the identity of a user, storing the SPI in immutable storage using an asymmetric encryption object of the user, and using the SPI to allow secure access to a digital resource.

An example secure multi-factor encrypted authentication system includes: an access portal including an asymmetric encryption object; an immutable storage communicating with the access portal using the asymmetric encryption object; an identity server communicating with both the access portal and the immutable storage; and a filing system receiving identity information from the identity server and returning a hash (CID).

An example non-transitory computer readable media including code segments executable on a processor having code segments for creating a Secure Personal Identifier (SPI) to authenticate the identity of a user, code segments for storing the SPI in immutable storage using an asymmetric encryption object of the user; and code segments for using the SPI to allow secure access to a digital resource.

These and other embodiments, features and advantages will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, but not to limit, the invention. The drawings include the following figures:

FIG. 1 is a block diagram of an example secure multi-factor encrypted authentication system;

FIG. 2 is a block diagram of an example processor system;

FIG. 3 is a flow diagram of an example secure multi-factor encrypted authentication method;

FIG. 4 is a flow diagram of an example method 48 for creating a Secure Personal Identifier (SPI) in response to a user request.

FIG. 5 is a flow diagram of an example method for creating an SPI of FIG. 4;

FIG. 6 is a flow diagram of an example method for obtaining identity information from a user of FIG. 5; and

FIG. 7 is a flow diagram of an example method for using an SPI for secure access to digital resources.

### DETAILED DESCRIPTION OF EXAMPLE EMBODIMENTS

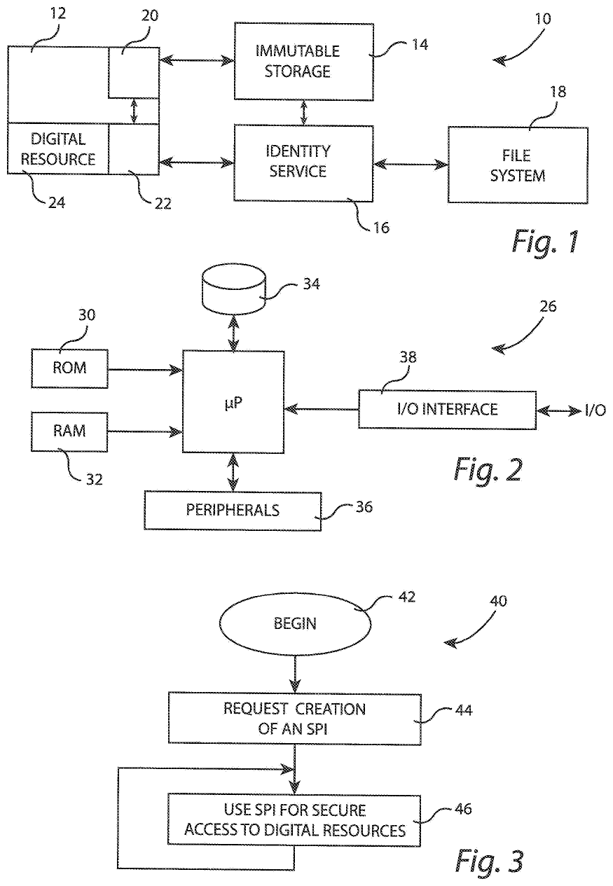

FIG. 1 is a block diagram of an example secure multi-factor encrypted authentication system 10 including an access portal 12, an immutable storage 14, an identity service 16, and a file system 18. The access portal 12, in this example embodiment, includes an immutable storage interface 20, an identity service interface 22, and a digital resource 24. In alternate embodiments, some or all of immutable storage interface 20, identity service interface 22, and digital resource 24 can be provided externally to the access portal 12. The access portal 12, immutable storage 14, identity service 16, and file system 18 can each be implemented by a digital processor system.

Access portal 12 can include a computerized device such as a smartphone, a computer tablet, or a personal computer. As used herein, a “smartphone” is a mobile telephone capable of communicating over the internet and of running applications or “apps.” A “computer tablet” is likewise a computerized system capable of communicating over the internet and of running applications. A personal computer is a computerized system operating under a variety of operating systems including, Microsoft Windows, Apple macOS, Linux, etc.

The immutable storage interface 20 of access portal 12, in this example, is implemented by an asymmetric encryption object. As used herein, an “object” is a software construct including data and processes. As used herein, “asymmetric encryption” is an encryption technique having an encryption key (a/k/a public key) and a different decryption key (a/k/a private key). Identity service interface 22 can be a part of original operating system of the access portal 12, code provided via a software development kit (“SDK”), or as an application or “app.” Digital resource 24 can be an internal or external resource, such as an app, a database, etc.

Immutable storage 14 has the property that, once written to, data is maintained indefinitely. As its name implies, the basic idea behind immutable storage is that the data storage will remain completely static and pristine for its entire existence, Immutable storage enables adopters to designate specific data that will be stored in a form that can never be tampered with, modified or removed. Immutable storage can be applied to data stored on most conventional storage media and platforms, including tape, disk, SSDs, or in the cloud. By “cloud” it is meant servers and systems providing computational and/or storage capability over the internet. A common type of cloud-based immutable storage is a public blockchain, such as Ethereum, which is a decentralized, open source blockchain with smart contract functionality. If, for example, immutable storage 14 includes the Ethereum blockchain, the immutable storage interface 20 can comprise a wallet holding the public key (“address”) and private key of the user. Another cloud-based file system that implements immutable storage is the Hadoop distributed file system (HDFS), which is part of a collection of open-source software utilities under the Apache Hadoop umbrella developed by the Apache Software Foundation.

Identity service 16 communicates with the access portal 12 via the identity service interface and coordinates the creation and use of a Secure Personal Identifier (C′SPI″) for the user. Identity service 16 also communicates with file system 18 to securely store personal data of the user. For example, file system 18 can be stored in the InterPlanetary File System (IPFS), which is file sharing peer-to-peer network, for storing and sharing data in a distributed file system. IPFS uses content-addressing by creating a Content ID (CID), which is a hash of the identity data, to uniquely identify each file in a global namespace connecting IPFS hosts.

FIG. 2 is a block diagram of an example digital processor system 26 including a microprocessor (μP) 28, read only memory (ROM) 30, random access memory (RAM), digital storage 34, peripherals 34, and an I/O Interface 38, A basic input/output system (BIOS) is typically stored, at least in part, in ROM 30, while the remainder of the operating system is often stored in digital storage 34. Additional applications, libraries, datasets, etc. can also be stored in digital storage 34. Each of the access portal 12, immutable storage 14, identity service 16, and file system 18 can include one or more of digital processor system 26. Also, access portal 12, immutable storage 14, identity service 16, and file system 18 can share one or more digital processor systems. For example, in certain embodiments all of access portal 12, immutable storage 14, identity service 16, and file system 18 can be run on a single computerized system and in other embodiments the access portal 12, immutable storage 14, identity service 16, and file system 18 can run on two or more computerized systems.

FIG. 3 is a flow diagram of an example secure multi-factor encrypted authentication method 40 which begins at 42 and, in an operation 44, a user makes a request for the creation of a Secure Personal Identifier (SPI). In the example where the immutable storage comprises a public blockchain, the SPI can be a non-fungible token (NFT) maintained in the cloud on a smart contract public blockchain such as Ethereum and can be accessed via an immutable storage interface configured as a wallet. The process then loops on the operation 46, using the SN for secure access to digital resources, such as digital resource 24 in this example, without requiring additional identity information.

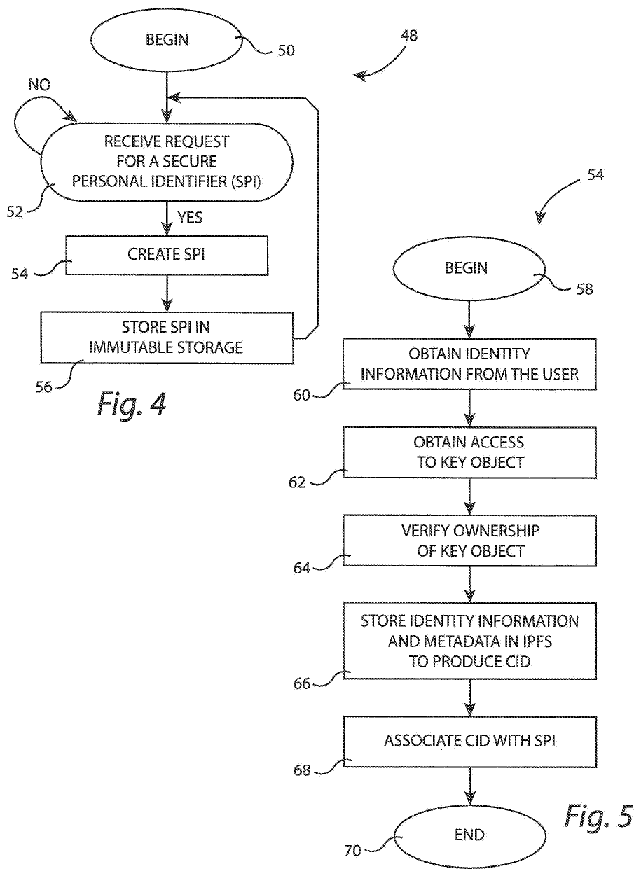

FIG. 4 is a flow diagram of an example method 48 for creating a Secure Personal Identifier (SPI) in response to a user request. Process 48 begins at 50 and, in an operation 52, it is determined whether it has received a request from a user for an SPI. If so, an SPI is created in an operation 54 and is stored in an immutable storage in an operation 56. In the forgoing example where the immutable storage is a public blockchain capable of smart contracts, the SPI can be an NIT. Control is then returned to operation 52.

FIG. 5 is a flow diagram of an example method 54 for creating an SPI. The process 54 begins at 58 and, in an operation 60, identity information is obtained from the user. For example, the user may be required to enter an account name and a password. Next, in an operation 62, access to the user's immutable storage interface is obtained, and the user's ownership of the immutable storage interface is verified in an operation 64, such as by storing a random sequence of numbers in the immutable storage with a public key and reading them back with a private key. In the example where the file system 18 is the InterPlanetary File System, an operation 66 stores the user identity information and optional metadata in the IPFS, which provides a content addressable hash CID. Finally, in an operation 68, a user-friendly name for the CID is provided in an operation 68 to serve as the SPI. Process 54 is then completed at 70.

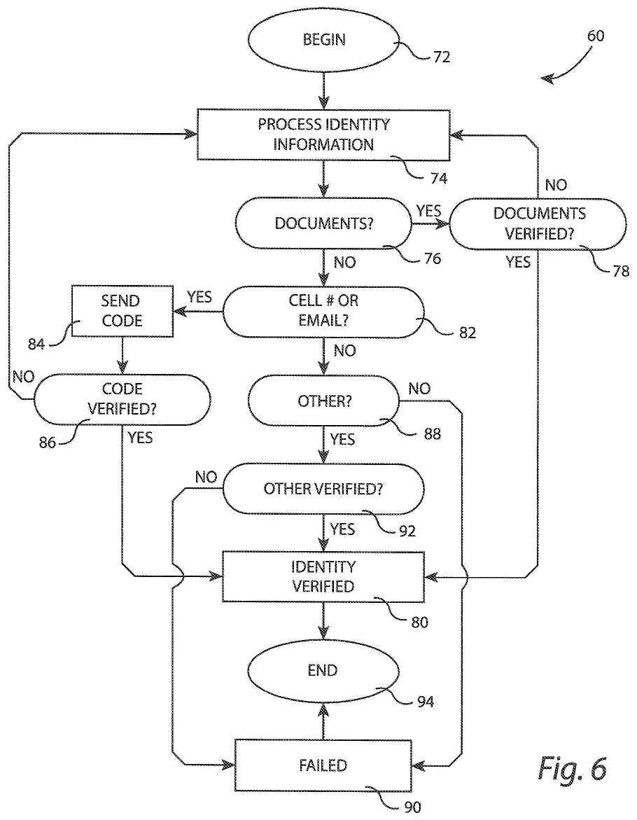

FIG. 6 is a flow diagram of an example method 60 for obtaining identity information from a user. The process 60 begins at 72 and, in an operation 74, processes the user identity information. If, in an operation 76, it, is determined that there are identity documents to process, an operation 78 verifies the document and an operation 80 verifies the identity of the user. If operation 78 does not verify the document, process control is returned to 74. If operation 76 determines that there are no documents to process, an operation 82 determines if the cell number and/or or email address of the user has been provided. If so, an operation 84 sends a code, typically in the form of a number of random numbers, to the cell phone by SMS message and/or the email via an email message. If the user enters the code properly in operation 86 the user identity has been authenticated and operational control reverts to 80. Otherwise, operational control returns to operation 74. If the user identity fails to authenticate by documents, SMS, and/or email, “other” forms of user identity authentication can be detected by operation 88. For example, biometric verification (e.g. fingerprint or facial recognition) can be used. If operation 88 does not detect “other” forms of user identification, the verification process fails at 90 and the process 60 ends at 94. If operation 88 detects “other” user identification, an operation 92 attempts to verify the user's identity. If successful, the user identity is verified by operation 80, and if unsuccessful, the verification process fails at 90 and the process 60 ends at 94.

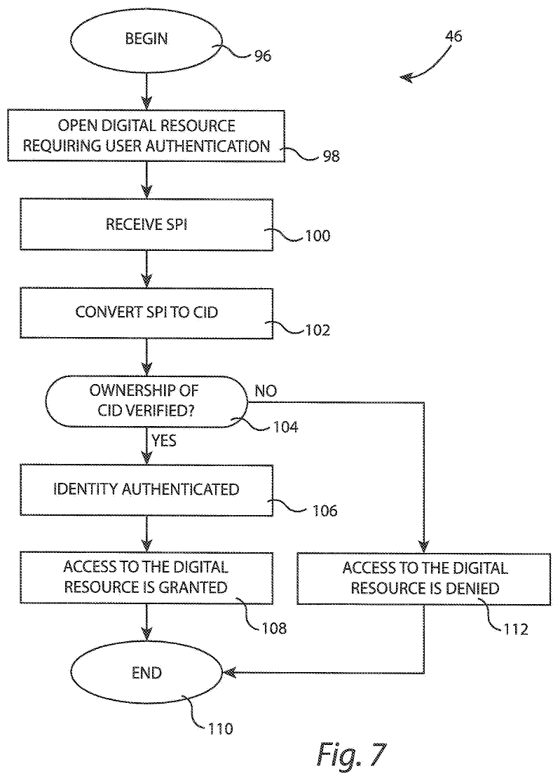

FIG. 7 is a flow diagram of an example method 46 for using the user's SPI for secure access to digital resources. The process 46 begins at 96 and, in an operation 98, a user opens a digital resource that requires user authentication. Next, in an operation 100, the user's SPI is retrieved from the immutable storage 14 and is converted into a CID hash in an operation 102. In an operation 104, if the ownership of the CID is verified, the user's identity authenticated in an operation 106 and access to the digital resource is granted in an operation 108 before the process 46 ends at 110. If operation 104 did not verify the ownership of the CID, access to the digital resource is denied in an operation 112, and the process ends at 110.

It will be appreciated that the implementation of the various processes of the examples discussed above provide a highly secure multi-factor encrypted user authentication. For example, in the embodiment where a user's SPI is a NFT stored on the Ethereum blockchain, the user can use the conveniently named NFT to provide secure, encrypted authentication to a digital resource, such as an app, without having to laboriously reenter identity information into each new app or other digital resource that the user accesses.

Although various embodiments have been described using specific terms and devices, such description is for illustrative purposes only. The words used are words of description rather than of limitation. It is to be understood that changes and variations may be made by those of ordinary skill in the art without departing from the spirit or the scope of various inventions supported by the written disclosure and the drawings. In addition, it should be understood that aspects of various other embodiments may be interchanged either in whole or in part. It is therefore intended that the claims be interpreted in accordance with the true spirit and scope of the invention without limitation or estoppel.

What is claimed is:

1. A secure multi-factor encrypted authentication method comprising:
creating a Secure Personal Identifier (SPI) to authenticate the identity of a user;
storing the SPI in immutable storage using an asymmetric encryption object of the user; and
using the SPI to allow secure access to a digital resource.

2. A secure multi-factor encrypted authentication method as recited M claim 1 wherein creating an SPI comprises:
receiving a request for an SPI from the user;
obtaining identity information from the user;
obtaining access to the asymmetric encryption object of the user;
verifying that the asymmetric encryption object belongs to the user; and
storing the identity information in a file system that creates a hash (CID) of the identity information.

3. A secure multi-factor encrypted authentication method as recited in claim 2 wherein metadata is also stored in the file system and forms a part of the CID.

4. A secure multi-factor encrypted authentication method as recited in claim 3 further comprising assigning a SPI name to the CID.

5. A secure multi-factor encrypted authentication method as recited in claim 2 wherein obtaining identity information from the user comprises at least one of receiving a document, an email address, and a telephone number from the user.

6. A secure multi-factor encrypted authentication method as recited in claim 5 wherein verifying that the document belongs to the user at least partially verifies the identity of the user.

7. A secure multi-factor encrypted authentication method as recited in claim 5 wherein verifying that at least one of the telephone number and the email address belongs to the user at least partially verifies the identity of the user.

8. A secure multi-factor encrypted authentication method as recited in claim 1 wherein using the SPI to allow secure access to the digital resource comprises:
opening the digital resource;
granting the digital resource access to the asymmetric encryption object; and
using the SPI to verify the identity information of the user.

9. A secure multi-factor encrypted authentication method as recited in claim 2 wherein the SPI comprises a non-fungible token (NTT) and the immutable storage is a public blockchain.

10. A secure multi-factor encrypted authentication method as recited in 9 wherein the asymmetric encryption object is a wallet including the NFT.

11. A secure multi-factor encrypted authentication method as recited in claim 1 wherein the file system includes an Interplanetary File System (IPFS).

12. A secure multi-factor encrypted authentication system comprising:
an access portal including an asymmetric encryption object;
an immutable storage communicating with the access portal using the asymmetric encryption object;
an identity server communicating with both the access portal and the immutable storage; and
a filing system receiving identity information from the identity server and returning a hash (CID).

13. A secure multi-factor encrypted authentication system as recited in claim 12 wherein the access portal is at least one of an internet connected mobile telephone, a tablet, and a personal computer (PC).

14. A secure multi-factor encrypted authentication system as recited in claim 13 wherein the immutable storage includes a public blockchain.

15. A secure multi-factor encrypted authentication system as recited in claim 14 wherein the filing system is an Interplanetary Filing System (IPFS).

16. Non-transitory computer readable media comprising code segments executable on a processor comprising:
code segments for creating a Secure Personal Identifier (SPI) to authenticate the identity of a user;
code segments for storing the SPI in immutable storage using an asymmetric encryption object of the user; and
code segments for using the SPI to allow secure access to a digital resource.

17. Non-transitory computer readable media comprising code segments executable on a processor as recited in claim 16 wherein code segments for creating an SPI comprises:
code segments receiving a request for an SPI from the user;
code segments obtaining identity information from the user;
code segments obtaining access to the asymmetric encryption object of the user;
code segments verifying that the asymmetric encryption object belongs to the user; and
code segments storing the identity information in a file system that creates a hash (CID) of the identity information.

18. Non-transitory computer readable media comprising code segments executable on a processor as recited in claim 17 wherein the SPI comprises a non-fungible token (NFT) and the immutable storage is a public blockchain.

19. Non-transitory computer readable media comprising code segments executable on a processor as recited in claim 18 wherein the asymmetric encryption object is a wallet including the NFT.

20. Non-transitory computer readable media comprising code segments executable on a processor as recited in claim 19 wherein the file system is an Interplanetary File System (IPFS).
